(19) United States
(12) Patent Application Publication
(10) Pub. No.: US 2014/0115445 A1
(43) Pub. Date: Apr. 24, 2014

(54) WEB PAGE VIEWING SERVER, WEB PAGE VIEWING SYSTEM, AND WEB PAGE VIEWING METHOD

(71) Applicant: FUJIFILM Corporation, Tokyo (JP)

(72) Inventor: Hironori YANO, Tokyo (JP)

(73) Assignee: FUJIFILM Corporation, Tokyo (JP)

(21) Appl. No.: 14/048,817

(22) Filed: Oct. 8, 2013

(30) Foreign Application Priority Data
Oct. 18, 2012 (JP) 2012-230585

(51) Int. Cl. G06F 17/21

(52) U.S. Cl. CPC G06F 17/211
USPC 715/238

(57) ABSTRACT

The present invention includes an imaging unit that repeatedly images a Web page to generate page images, a detecting unit that repeatedly detects a change in the page images, an area determining unit that determines whether an update area in the page images where a change is detected and a display area displayed on a display screen of the portable terminal have an overlap, and an image transmission control unit that causes an image transmitting unit to transmit an image including an overlap area between the update area and the display area to the portable terminal when the update area and the display area have an overlap and does not cause the image transmitting unit to transmit the image when the update area and the display area do not have an overlap.

### BACKGROUND OF THE INVENTION

1. Field of the Invention

The present invention relates to a Web page viewing server that converts a Web page for PCs (personal computers) containing dynamic contents to an image of a size displayable on a display screen of a portable terminal and distributes the image.

2. Description of the Related Art

When a Web page created for PCs (personal computers) is viewed at a portable terminal with low performance such as a portable telephone, several problems occur. For example, when a Web page having a rich content such as Flash (registered trademark) embedded therein is viewed at a portable terminal, a correct display cannot be made on the portable terminal unless software that renders that rich content is present on the portable terminal.

To address the problems, a Web viewing system is provided where a Web page is imaged on a server side and a portable terminal merely displays an image transmitted from the server side (refer to Japanese Patent Application Laid-Open No. 2012-43140 and Japanese Patent Application Laid-Open No. 2006-155333).

In the invention described in Japanese Patent Application Laid-Open No. 2012-43140, it is determined whether a Web page requested for viewing includes a rich content, a rich content area is extracted, and a change of the rich content in the rich content area is detected. When a change of the rich content is detected, the Web page including the change-detected rich content is converted to image data, and the image data is transmitted to the portable terminal.

### SUMMARY OF THE INVENTION

However, when a Web page including a dynamic content is viewed, computation load on the server is disadvantageously increased, and also a communication traffic volume between the server and the portable terminal is disadvantageously increased. Moreover, it is difficult for the server side to support all rich contents of various types.

In the invention described in Japanese Patent Application Laid-Open No. 2012-43140, only the image in the rich content area where a change is detected is transmitted to the portable terminal. Therefore, the communication traffic volume can be reduced compared with the case where image data corresponding to the entire Web page is transmitted to the portable terminal. However, it is difficult to support an unknown rich content. That is, if the rich content is known, the type and area of the rich content can be specified. In the case of an unknown rich content, however, the type and area cannot be specified with ease. For example, it is difficult to support a change of coordinates of a DOM (Document Object Model) element in JavaScript (registered trademark).

In the invention described in Japanese Patent Application Laid-Open No. 2006-155333, there is no mechanism for reproducing a dynamic content such as a moving image. Therefore, it is difficult to view a Web page including a dynamic content.

An object of the present invention is, when a Web page including a dynamic content is imaged on a server side to allow Web page viewing at a portable terminal, while reliably performing image update of a dynamic content portion, to reduce load on the server side and a communication traffic volume between the server side and the portable terminal.

To achieve the above object, the present invention provides a Web page viewing server including: a viewing request accepting unit that accepts a request for viewing a Web page from a portable terminal; a Web page obtaining unit that obtains the Web page in response to the viewing request accepted by the viewing request accepting unit; an imaging unit that repeatedly images the Web page obtained by the Web page obtaining unit to generate page images corresponding to the Web page; an image transmitting unit that transmits all or part of the page images generated by the imaging unit to the portable terminal; a detecting unit that repeatedly detects a change in the page images; an area determining unit that determines whether an update area where a change is detected in the page images by the detecting unit and a display area of the page image displayed on a display screen of the portable terminal have an overlap; and an image transmitting unit that causes the image transmitting unit to transmit, to the portable terminal, an image including an overlap area between the update area and the display area in the page images when the update area and the display area have an overlap and does not cause the image transmitting unit to perform image transmission to the portable terminal when the update area and the display area do not have an overlap.

With this, it is determined whether an overlap between the update area where a change is detected in the page images by the detecting unit and the display area of the page image displayed on the display screen of the portable terminal have an overlap. When the update area and the display area have an overlap, an update image including an overlap area between the update area and the display area in the page images is transmitted to the portable terminal. When the update area and the display area do not have an overlap, image transmission to the portable terminal is not performed. Therefore, while reliably performing image update of a dynamic content portion, it is possible to suppress a computation amount on the server side to reduce load on the server side and also reduce a communication traffic volume between the server side and the portable terminal.

In an aspect of the present invention, when a change in the page images is not detected, the detecting unit increases at least one time interval of a time interval for imaging each of the page images by the imaging unit and a time interval for detecting a change in the page images by the detecting unit. With this, the computation amount on the server side can be suppressed to reduce load on the server.

In an aspect of the present invention, when a change in the page images is detected, the detecting unit shortens at least one time interval of a time interval for imaging each of the page images by the imaging unit and a time interval for detecting a change in the page images by the detecting unit. Also, in an aspect of the present invention, when a change in the page images is detected, the detecting unit sets the time interval at a minimum time interval. With this, reliable detection can be performed in a period in which there is a high possibility that the page image is changed.

In an aspect of the present invention, the Web page viewing server further includes an operation event receiving unit that receives, from the portable terminal, operation event information indicating that an operation has been performed at the portable terminal, wherein when the operation event information is received from the portable terminal, the detecting unit shortens at least one time interval of a time interval for imaging each of the page images by the imaging unit and a time interval for detecting a change in the page images by the detecting unit. Also, in an aspect of the present invention, when the operation event information is received from the portable terminal, the detecting unit sets the time interval at a minimum time interval. With this, reliable detection can be performed in a period in which there is a high possibility that the page image is changed.

In an aspect of the present invention, the detecting unit divides each of the page images into a lattice shape, calculates hash values of a plurality of respective divisional areas, and specifies a divisional area where a change in the hash values is detected as the update area. With this, the computation amount on the server side can be suppressed to reduce load on the server.

The present invention also provides a Web page viewing system including Web page viewing server and a portable terminal, and the portable terminal includes a communication unit that receives all or part of the page images from the image transmitting unit of the Web page viewing server, an image synthesizing unit that generates, when the overlap area between the page images is received from the communication unit, a synthetic image obtained by synthesizing an image including the overlap area and the image in the display area displayed on the display screen, a display unit that displays the images received by the communication unit and the synthetic image generated by the image synthesizing unit, and a control unit that causes operation event information including area information indicating at least a display area of the page image displayed on the display unit.

Furthermore, the present invention provides a Web page viewing method of converting a Web page corresponding to a request for viewing the Web page from a portable terminal to a page image and distributing the page image to the portable terminal, and the Web page viewing server performing steps including a viewing request accepting step of accepting the request for viewing the Web page from the portable terminal, a Web page obtaining step of obtaining the Web page in response to the viewing request accepted in the viewing request accepting step, an imaging step of repeatedly imaging the Web page obtained in the Web page obtaining step to generate page images corresponding to the Web page, an image transmitting step of transmitting all or part of the page images generated in the imaging step to the portable terminal, a detecting step of repeatedly detecting a change in the page images, an area determining step of determining whether an update area where a change is detected in the page images in the detecting step and a display area of the page image displayed on a display screen of the portable terminal have an overlap, and an image transmitting step of transmitting, in the image transmitting step, to the portable terminal, an image including an overlap area between the update area and the display area in the page images when the update area and the display area have an overlap and not performing image transmission to the portable terminal when the update area and the display area do not have an overlap.

In an aspect of the present invention, the potable terminal performs steps including an image receiving step of receiving all or part of the page images from the image transmitting unit of the Web page viewing server, an image synthesizing step of generating, when the overlap area between the page images is received in the image receiving step, a synthetic image obtained by synthesizing an image including the overlap area and the image in the display area displayed on the display screen, an image display step of displaying the images received in the image receiving step and the synthetic image generated in the image synthesizing step on the display screen, and an operation event information transmitting step of transmitting operation event information including area information indicating at least a display area of the page image displayed on the display screen.

Still further, the present invention provides a non-transitory computer readable medium having a program causing a computer to perform functions including a viewing request accepting function of accepting a request for viewing a Web page from a portable terminal, a Web page obtaining function of obtaining the Web page in response to the viewing request accepted by the viewing request accepting function, an imaging function of repeatedly imaging the Web page obtained by the Web page obtaining function to generate page images corresponding to the Web page, an image transmitting function of transmitting all or part of the page images generated by the imaging function to the portable terminal, a detecting function of repeatedly detecting a change in the page images, an area determining function of determining whether an update area where a change is detected in the page images by the detecting function and a display area of the page image displayed on a display screen of the portable terminal have an overlap, and an image transmitting function of causing the image transmitting function to transmit, to the portable terminal, an image including an overlap area between the update area and the display area in the page images when the update area and the display area have an overlap and does not cause the image transmitting function to perform image transmission to the portable terminal when the update area and the display area do not have an overlap.

According to the present invention, when a Web page including a dynamic content is imaged on a server side to allow Web page viewing at a portable terminal, it is possible to reliably perform image update of a dynamic content portion and reduce load on the server side and a communication traffic volume between the server side and the portable terminal.

### BRIEF DESCRIPTION OF THE DRAWINGS

FIG. 1 is a schematic view of the state where a Web for PCs is viewed by a PC and a portable terminal;

FIG. 2 is an entire structural view of an example of a Web page viewing system;

FIG. 3 is a flowchart depicting a flow of an example of a Web page viewing process;

FIG. 4 is a diagram depicting an example when an update area and a display area do not have an overlap;

FIG. 5A is a diagram depicting an example when the update area and the display area have an overlap;

FIG. 5B is a diagram for use in describing the overlap area when the update area and the display area have an overlap;

FIG. 6 is a flowchart depicting a basic flow of an operation event process;

FIG. 7 is a diagram of an example of the operation event invention;

FIG. 8 is a flowchart depicting a flow of an example of a screen capture timing changing process;

FIG. 9 is a diagram for use in describing that a page image is divided into a lattice shape to detect a hash value for each divisional area;

FIG. 10 is a diagram for describing that a divisional area where the hash value is detected is specified as an update area.

### DETAILED DESCRIPTION OF THE PREFERRED EMBODIMENTS

In the following, an embodiment of the present invention is described in detail with reference to the attached drawings.

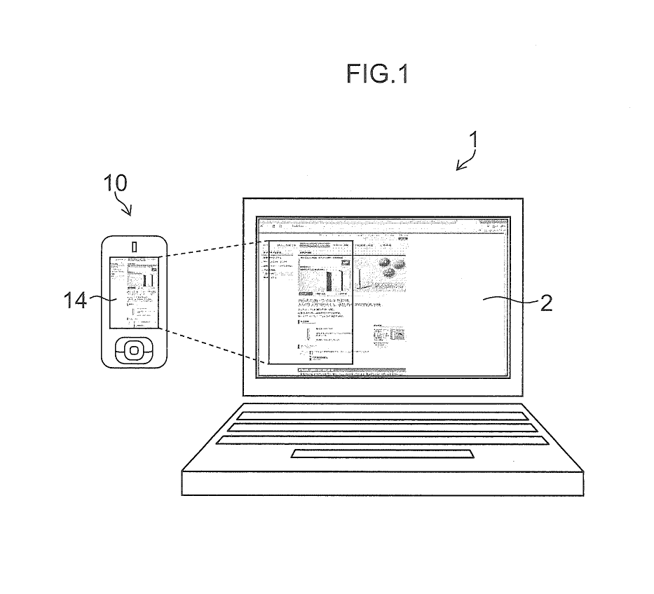

FIG. 1 is a schematic view of the state where a Web page for PCs is viewed by using a display unit 14 of a portable terminal 10 in a manner similar to that where the Web page is viewed by using a display unit 2 of a PC (personal computer) 1. As depicted in the drawing, according to a Web page viewing system, a Web page for the PC 1 can be viewed by the portable terminal 10.

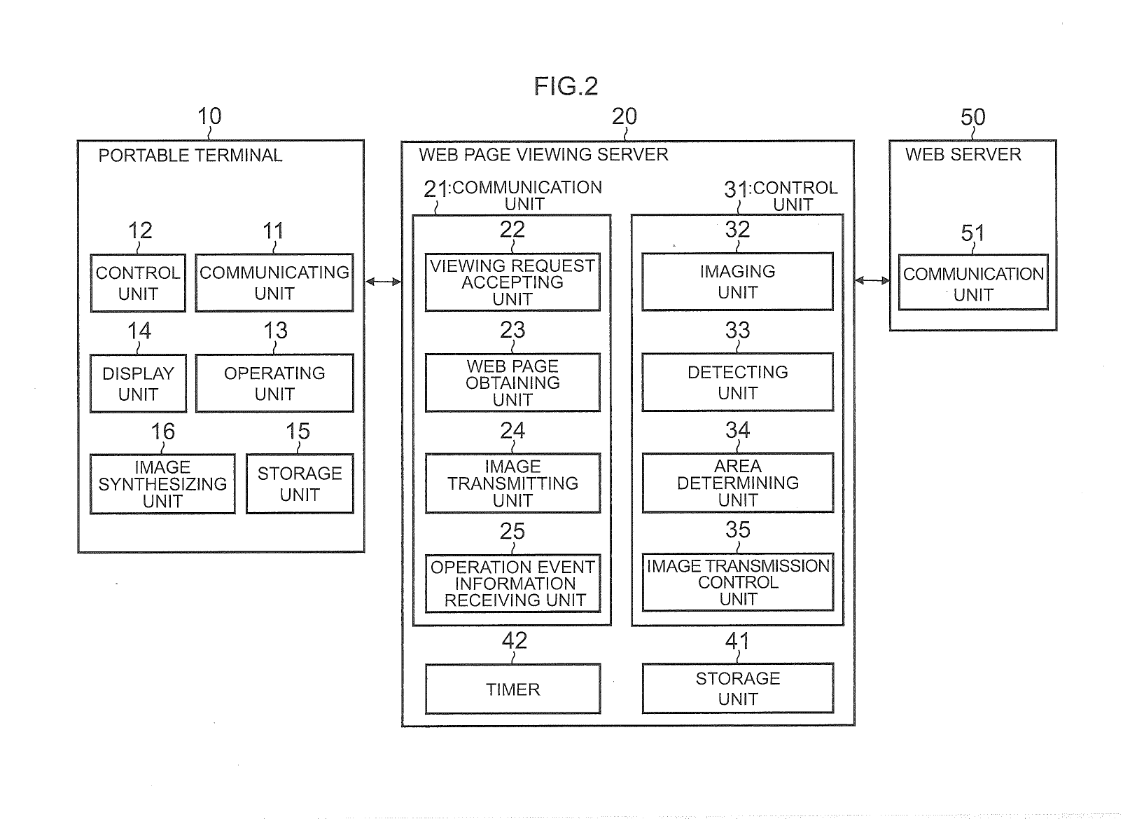

FIG. 2 is an entire structural view of an example of the Web page viewing system in the present embodiment. As depicted in the drawing, the Web page viewing system of the present example is configured to include the portable terminal 10 that can display an image, a Web page viewing server 20 that converts a Web page for PCs to an image that can be displayed on the portable terminal 10 and distributes the image to the portable terminal 10, and a Web server 50 that provides the Web page for PCs.

The portable terminal 10 is configured to include a communication unit 11 that communicates with the Web page viewing server 20, a control unit 12 that controls each unit of the portable terminal 10 by following a program to perform various processes, an operating unit 13 that accepts an operation (instruction input) from user, a display unit 14 that can display an image, a storage unit 15 that stores a program (client program) on a portable terminal 10 side and various information, and an image synthesizing unit 16 that synthesizes images.

The portable terminal 10 and the Web viewing server 20 are connected to each other via an electric communication line such as the Internet. The communication unit 11 of the portable terminal 10 and a communication unit 21 of the Web page viewing server 20 perform communication via the electric communication line by following a predetermined communication protocol. The communication unit 11 of the portable terminal 10 receives an entire or part of a page image corresponding to a Web page from the Web page viewing server 20.

The control unit 12 causes an image obtained from the Web page viewing server 20 via the communication unit 11 to be displayed on the display unit 14, and performs a process following the instruction input of the user accepted by the operating unit 13. The control unit 12 is configured of, for example, a microcomputer.

The operating unit 13 includes a power supply button, number keys, a cross key, an enter key, etc. not shown. By operating the operating unit 13, the user can make various instruction inputs to the portable terminal 10. As the operating unit 13, a touch panel may be placed on a front surface of the display unit 14. Operation event information including area information indicating a display area in a page image displayed on the display unit 14 is transmitted by the communication unit 11 to the Web page viewing server by following the control of the control unit 12.

The display unit 14 is formed of a display device (for example, a liquid-crystal display device) that can display an image based on an image signal inputted from the control unit 12.

When an image including an overlap area of a page image is received by the communication unit 11, the image synthesizing unit 16 generates a synthetic image by synthesizing the image including the overlap image and an image in the display area displayed on a screen (display screen) of the display unit 14. The synthetic image generated by the image synthesizing unit 16 is displayed on the display unit 14 under the control of the control unit 12.

The Web page viewing server 20 (this may hereinafter simply referred to as a “server”) is configured to includes a communication unit 21 that communicates with the portable terminal 10 and the Web server 50, a control unit 31 that controls each unit of the server 20, a storage unit 41 that stores a Web page viewing program that allows viewing of a Web page from the portable terminal 10 and also stores various information, and a timer 42 that measures various time intervals. The control unit 31 is configured of, for example, a microcomputer.

The communication unit 21 is configured to include a viewing request accepting unit 22 that accepts a request for viewing a Web page from the portable terminal 10, a Web page obtaining unit 23 that obtains a Web page from the Web page server 50 in response to the viewing request accepted by the viewing request accepting unit 22, an image transmitting unit 24 that transmits an entire or part of a page image generated by the imaging unit 32 of the control unit 31, which will be described further below, to the portable terminal 10, and an operation event information receiving unit 25 that receives, from the portable terminal 10, operation event information indicating that an operation has been performed at the portable terminal 10 and also indicating operation details.

The viewing request accepting unit 22 of this example obtains a URL (Uniform Resource Locator) of a Web page from the portable terminal 10. The Web page obtaining unit 23 of the this example obtains a Web page based on the URL obtained from the portable terminal 10.

The control unit 31 is configured to include an imaging unit 32 that repeatedly images the Web page obtained by the Web page obtaining unit 23 from the Web server 50 to generate images corresponding to that Web page (hereinafter referred to as “page images”), a detecting unit 33 that repeatedly detects a change in the page images generated by the imaging unit 32, an area determining unit 34 that determines whether an area where the change is detected in the page images by the detecting unit 33 (hereinafter referred to as an “update area”) and an area of each page image displayed on the display screen of the portable terminal 10 (hereinafter referred to as a “display area”) have an overlap, and an image transmission control unit 35 that controls image transmission to the portable terminal 10.

The image transmission control unit 35 performs control as follows. When the update area and the display area have an overlap, the image transmission control unit 35 causes the image transmitting unit 24 to transmit an image including an overlap area between the update area and the display area in each page image to the portable terminal 10. When the update area and the display area do not have an overlap, the image transmission control unit 35 does not cause the image transmitting unit 24 to perform image transmission to the portable terminal 10.

When detecting no change in the page images, the detecting unit 33 of this example increases at least either one of a time interval for imaging a page image by the imaging unit 32 and a time interval for detecting a change in the page images by the detecting unit 33. When detecting a change in the page images, the detecting unit of this example shortens the time interval increased when detecting no change in the page images (the time interval for imaging a page image by the imaging unit 32 and/or the time interval for detecting a change in the page images by the detecting unit 33). When detecting a change in the page images, the detecting unit of this example sets the time interval increased when detecting no change in the page images at a minimum time interval (for example, one second).

Also, when the operation event information receiving unit 25 receives operation event information from the portable terminal 10, the detecting unit 33 of this example sets at least either one of the time interval for imaging a page image by the imaging unit 32 and the time interval for detecting a change in the page images by the detecting unit 33 at a minimum time interval.

The imaging unit 32 of this example images a Web page for each page. With this, a page image is generated for each page. The page image generated by the imaging unit 32 is outputted to a specific buffer (screen buffer) in the storage unit 41. This image output to the storage unit 41 may be hereinafter referred to as “rendering”. The imaging unit 32 of this example repeatedly images one Web page. With this, the page image dynamically changing with time is rendered in the screen buffer in the storage unit 41. The detecting unit 33 of this example captures entire page images for one page repeatedly rendered in the screen buffer of the storage unit 41 and detects whether at least a partial change has occurred between a page image captured this time and a page image captured at the previous time. The detecting unit 33 of this example captures entire page images and detects a change. This capture of entire page images may be hereinafter referred to as “image capture”.

In the present invention, specifying an update area in the page image by the detecting unit 33 is not restricted to specifying an update area by actually comparing pixel values of the page image captured at the previous time and pixel values of the page image captured this time. A page image may be divided by the detecting unit 33 into a lattice shape, a hash value of each pixel value of a plurality of divisional areas may be calculated, and a divisional area where a change of a hash area is detected may be specified as an update area. Also, detection of a change in page images may be achieved by obtaining an image rendering event of an operating system.

<Process Flow of Web Page Viewing Method>

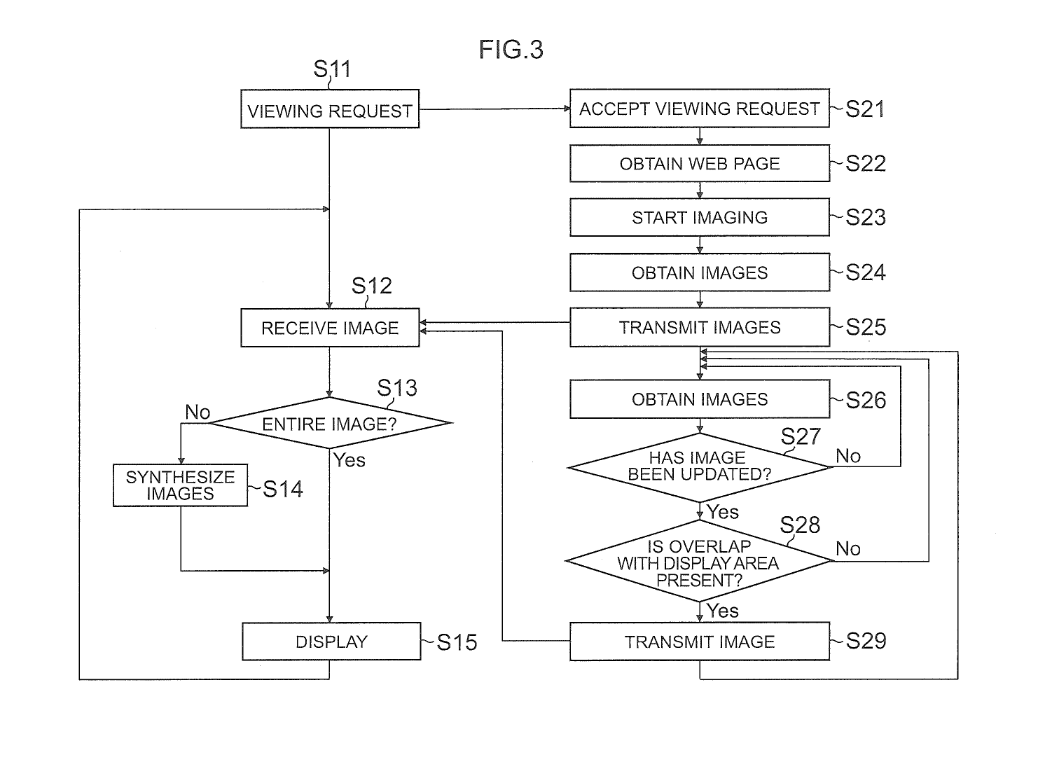

FIG. 3 is a flowchart depicting a flow of a Web page viewing process in the Web page viewing system depicted in FIG. 2. Steps S11 to S15 are performed by following the program (client program) stored in the storage unit 15 of the portable terminal 10 under the control of the control unit 12 of the portable terminal 10. Also, in this process, steps S21 to S29 are performed by following a program (server program) stored in the storage unit 41 of the server 20 under the control of the control unit 31 of the server 20 (the Web page viewing server).

First, by following the control of the control unit 12 of the portable terminal 10, a Web page viewing request is transmitted from the communication unit 11 of the portable terminal 10 to the server 20 (step S11). For example, a Web page viewing request is made by using a HTTP (HyperText Transfer Protocol) with a URL (Uniform Resource Locator) of a Web page.

The Web viewing request transmitted from the portable terminal 10 is accepted by the viewing request accepting unit 22 of the server 20 (step S21).

Next, by the Web page obtaining unit 23 of the server 20, the Web page viewing request is transmitted from the server 20 to the Web server 50 and a Web page corresponding to the viewing request is obtained from the Web server 50 (step S22).

Next, by the imaging unit 32 of the server 20, imaging the obtained Web page is started and page images corresponding to the Web page are repeatedly generated (step S23). That is, analyzing and rendering the Web page are repeatedly performed. The generated page images are repeatedly stored in the storage unit 41. The imaging unit 32 of this example executes a so-called Web browser program, and outputs an image (page image) such as an image to be outputted to one screen of the display unit 2 of the PC 1 of FIG. 1 to the specific area (screen buffer) of the storage unit 41.

Next, by the control of the image transmission control unit 35 of the server 20, all page images (entire images) for one page are obtained (captured) in this example from the screen buffer of the storage unit 41 (step S24), and the obtained all page images (entire images) for one page are transmitted by the image transmitting unit 24 to the portable terminal 10 (step S25).

Each page image transmitted from the server 20 is received by the communication unit 11 of the portable terminal 10 (step S12). The received page image is stored in the storage unit 15 of the portable terminal 10.

Next, the control unit 12 of the portable terminal 10 determines whether the page image received from the server 20 is an entire image or a partial image (step S13). When the page image is an entire image, the page image is stored in the storage unit 15 of the portable terminal 10 as an initial entire image without update, and an image of the entire image in an initial display area (area corresponding to the screen size of the display unit 14 of the portable terminal 10) is displayed on the screen (display screen) of the display unit 14 of the portable terminal 10 (step S15). When the page image is a partial image, the received partial image and the entire image stored in the storage unit 15 are synthesized together (step S14), and an image of the entire image after synthesis in the present display area is displayed on the screen (display screen) of the display unit 14 of the portable terminal 10 (step S15).

On a server 20 side, the image transmission control unit 35 of the server 20 obtains (captures) all page images (entire images) from the specific area (screen buffer) of the storage unit 41 (step S26), and the detecting unit 33 of the server 20 detects a change in the page images, determining whether a change is detected in the page images (whether an update is made) (step S27).

When a change in the page images is detected (Yes at step S27), the area determining unit 34 determines whether an area (update area) where a change is detected in the page images by the detecting unit 33 and a display area in each page image displayed on the screen (display screen) of the display unit 14 of the portable terminal 10 have an overlap (step S28).

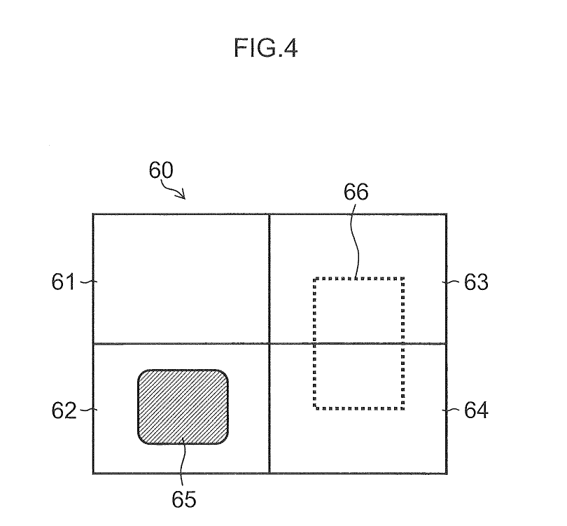

For example, as depicted in FIG. 4, a page image 60 is divided into a plurality of (four in this example) divisional areas 61, 62, 63, and 64, and it is determined whether an image change occurs in each of these four divisional areas 61 to 64. If an image in a portion indicated by a reference numeral 65 is changed, an image change in the divisional area 62 (update area) including the changed image 65 is detected. In the case depicted in FIG. 4, it is determined by the area determining unit 34 at step S28 that the update area (the divisional area 62) and a display area 66 do not have an overlap, and image transmission (step S29) is not performed.

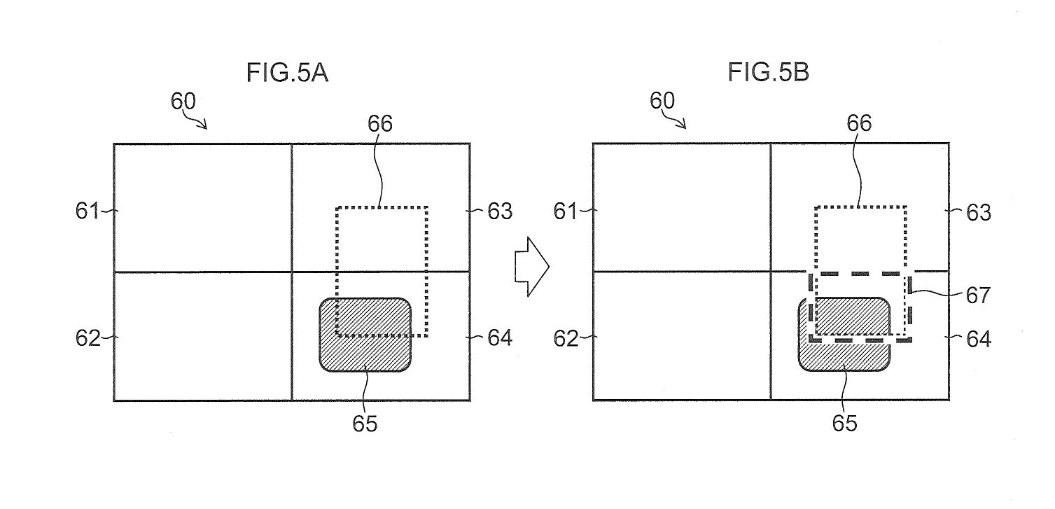

For example, as depicted in FIG. 5A, when a portion indicated by the reference numeral 65 is changed, an image change is detected in the divisional area 64 including the changed image 65 (update area). In the case depicted in FIG. 5A, it is determined by the area determining unit 34 at step S28 that the update area (the divisional area 64) and the display area 66 have an overlap, and image transmission (step S29) is performed.

In the case depicted in FIG. 5A, as depicted in FIG. 5B, an image including an overlap area 67 between the update area (divisional area 64) and the display area 66 is extracted from the page image after change, and is transmitted to the portable terminal 10. In this case, the entire image in the divisional area 64 (update area) where an image change is detected may be transmitted to the portable terminal 10, or only the image in the overlap area 67 may be transmitted to the portable terminal 10. In the former case (when the entire image in the divisional area 64 is transmitted), it is not necessary to calculate the range of the overlap area 67, and therefore the process is simplified. In the latter case (when only the image in the overlap area 67 is transmitted), only the image in the overlap area 67 is transmitted to the portable terminal 10, and therefore a communication traffic volume can be decreased.

When a change in the page images is not detected (No at step S27) or when the update area (62 of FIG. 4) in the page images and the display area (66 in FIG. 4) of the portable terminal 10 do not have an overlap (No at step S28), the procedure returns to step S26, repeatedly obtaining (capturing) page images and detecting the presence or absence of an update.

<Operation Event>

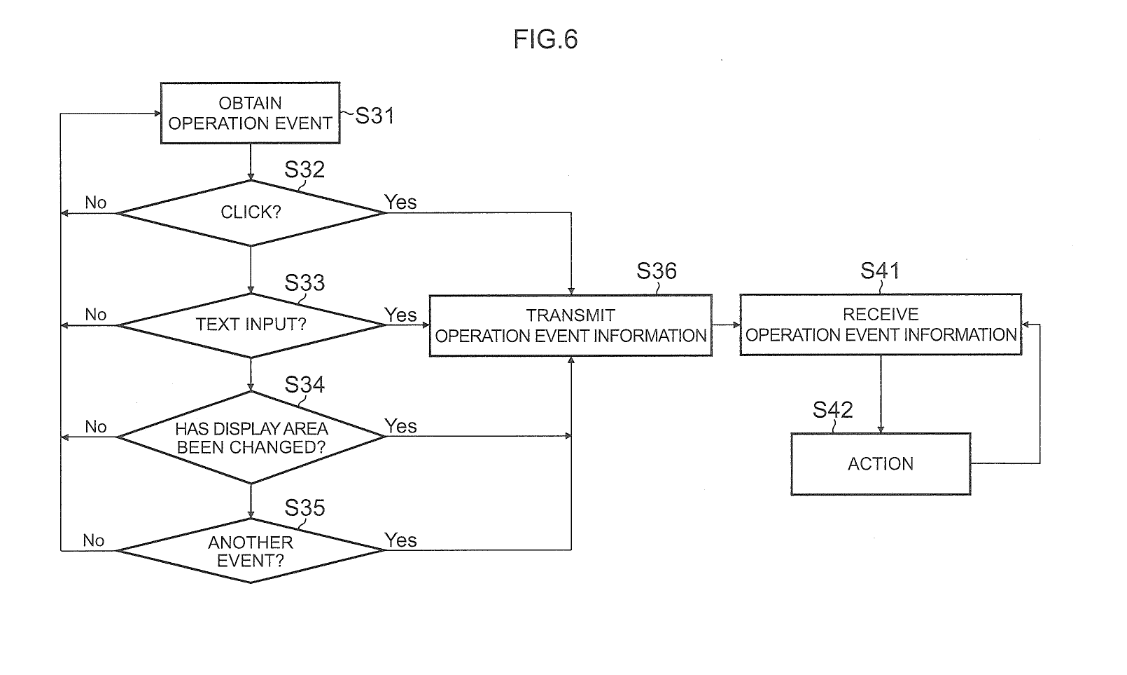

FIG. 6 is a flowchart depicting a basic flow of an operation event process in the Web page viewing system depicted in FIG. 2. In this process, steps S31 to S36 are performed by following the program (client program) of the portable terminal 10 under the control of the control unit 12 of the portable terminal 10. Also in this process, steps S41 and S42 are performed by following the program (server program) of the Web page viewing server 20 under the control of the control unit 31 of the Web page viewing server 20.

First, the control unit 12 of the portable terminal 10 obtains an operation event indicating that an operation by the operating unit 13 has been performed (step S31).

Next, the control unit 12 of the portable terminal 10 determines whether the operation event is a click (step S32), whether the operation event is a text input (step S33), whether the operation event is a change of the display area (step S34), and whether the operation event is another event (step S35). When the operation event is an event of which the server 20 is to be notified, operation event information indicating that the operation has been performed is transmitted to the server 20 (step S36).

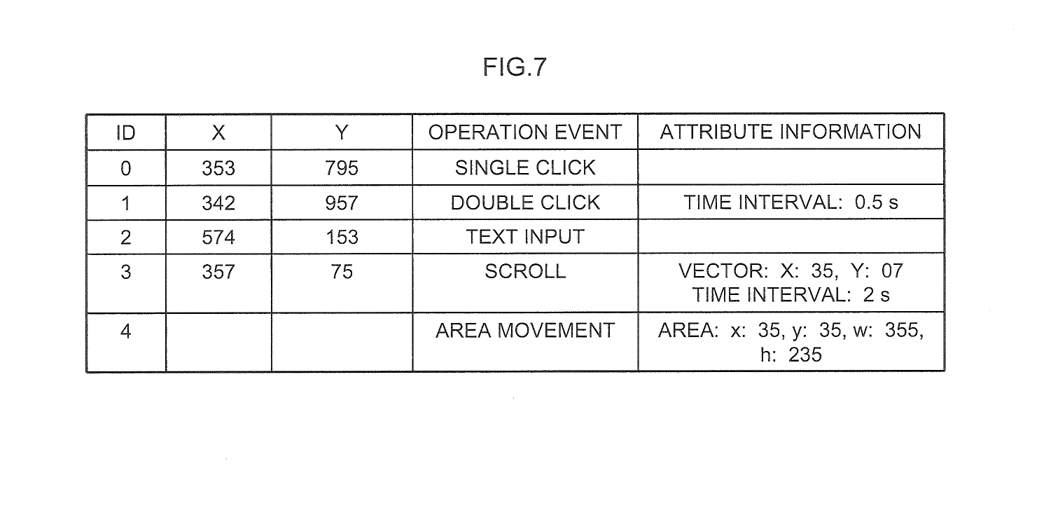

To the operation event information, for example, as depicted in FIG. 7, an identification information ID of the operation event, an operation position (X, Y), and attribute information are added. The ID represents unique identification information provided to each operation. The operation position (X, Y) indicates an X coordinate and a Y coordinate specified by the operation. The operation event represents an event specified by the operation. For example, when the screen is tapped, the event is determined as a “click” (single click or double click) event. When the display area is changed by drag and drop or by enlargement or reduction on the screen, the event is determined as an “area movement” event. The attribute information represents auxiliary information specified by the operation.

The operation event information of this example is as follows.

ID=0: Single click. No attribute information.

ID=1: Double click. Attribute information is a click time interval (unit: second).

ID=2: Text input. Attribute information is input text.

ID=3: Scroll. Attribute information is a vector (X, Y) and a time interval (unit: second). The vector represents a direction, in addition to scroll coordination information represented by X and Y. The time interval represents a scroll time interval.

ID=4: Area movement. Attribute information is movement destination area information (an X coordinate and a Y coordinate of a representative position of a movement destination area, and a width w and a height h of that area)

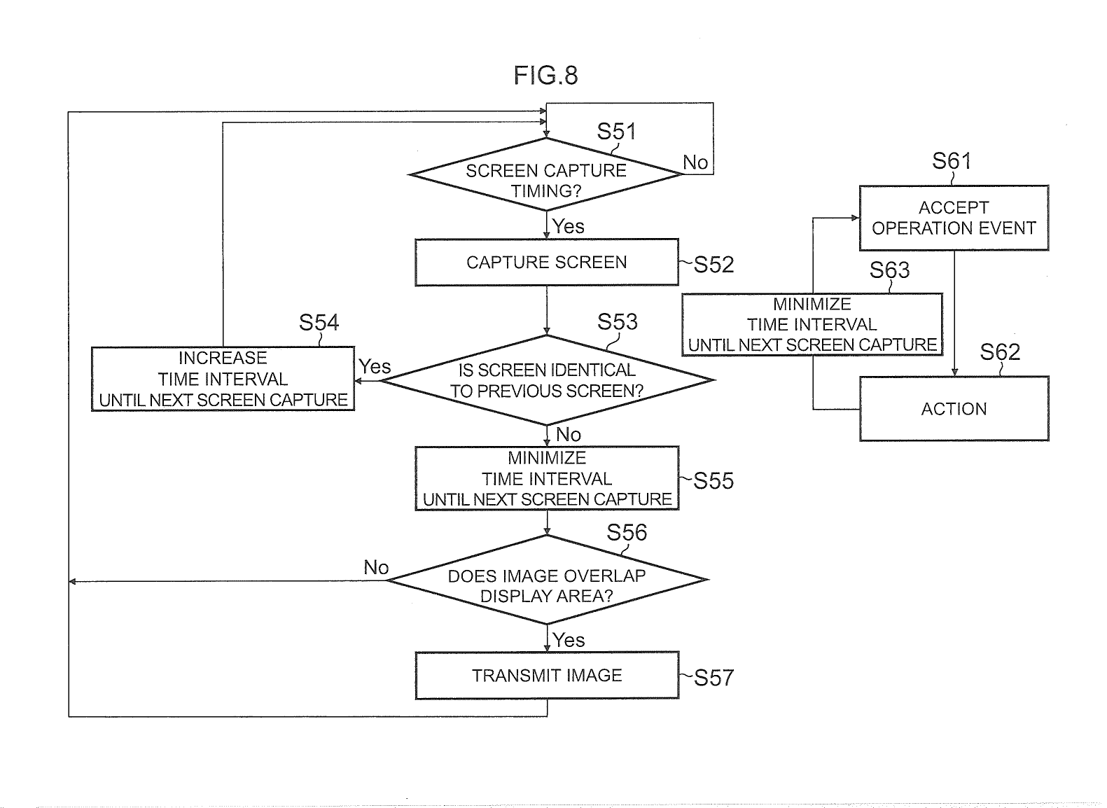

As depicted in FIG. 3 and FIG. 8, the portable terminal 10 of this example performs an image receiving step of receiving all or part of page images from the server 20 (step S12 of FIG. 6), an image synthesizing step of, when receiving an image including an overlap area in the page images, generating a synthetic image by synthesizing the image including the overlap area and an image in the display area displayed on the display screen of the display unit 14 (step S14 of FIG. 6), an image displaying step of displaying the image received at the image receiving step and causing the synthetic image generated at the image synthesizing step to be displayed on the display unit 14 (step S15 of FIG. 6), and an operation event information transmitting step of transmitting, to the server 20, at least operation event information including area information indicating a display area in the page images displayed on the display unit 14 (step S36 of FIG. 8).

<Screen Capture Time Interval Changing Process>

FIG. 8 depicts details of an example of steps S26 (image obtaining step) to S29 (image transmitting step) of FIG. 3 at the server 20 of the present embodiment. In this process (screen capture time interval changing process), steps S51 to S57 and S61 to S63 are performed by following the program (server program) stored in the storage unit 41 of the server 20 under the control of the control unit 31 of the server 20.

Here, “screen capture” means that the entire page image generated by the imaging unit 32 is temporarily stored (obtained). That is, the entire page image written by the imaging unit 32 of the server 20 in the specific area (screen buffer) of the storage unit 41 of the server 20 is temporarily stored so as not to be rewritten by the imaging unit 32 of the server 20. Here, the entire page image is “stored” but is not required to be copied, and it is enough to protect a page image write area as an area for image change detection and set a vacant area of the storage unit 41 as a write area for a new page image.

First, the detecting unit 33 of the server 20 determines whether the present point in time measured by the timer 42 of the server 20 is screen capture timing (step S51).

When the time is screen capture timing (Yes at step S51), the detecting unit 33 of the server 20 captures the entire page image stored by the imaging unit 32 of the server 20 in the storage unit 41 of the server 20 (step S52). This step S52 corresponds to step S26 of the FIG. 3.

Next, the detecting unit 33 of the server 20 determines whether the page image captured this time is identical to the page image captured at the previous time (step S53). This step S53 corresponds to step S27 of FIG. 3.

When the page image captured this time is identical to the page image captured at the previous time (Yes at step S53), the time interval until the next page image is captured is increased (step S54). That is, when not detecting a change in the page images, the detecting unit 33 increases the time interval for detecting a change in the page images by the detecting unit 33. The detecting unit 33 may increase the time interval for imaging a page image by the imaging unit 32. For example, if the present time interval is one second, the time interval is set at two seconds.

When the page image captured this time is different from the page image captured at the previous image (No at step S53), the time interval until the next page image is captured is set at a minimum time interval (for example, one second) (step S55). That is, when detecting a change in the page images is detected, the detecting unit 33 shortens the time interval for detecting a change in the page images by the detecting unit 33. The detecting unit 33 may shorten the time interval for imaging a page image by the imaging unit 32.

Steps S56 and S57 correspond to steps S28 and S29, respectively, of FIG. 3.

Also, when operation event information is received by the operation event information receiving unit 25 of the server 20 from the portable terminal 10, that is, when operation event information of the portable terminal 10 is received (when operation event is accepted) (step S61), an action is performed according to the received operation event information (step S62), and the time interval until the next image is captured is set at a minimum time interval (for example, one second) (step S63). That is, when the operation event invention is received from the portable terminal 10, the detecting unit 33 shortens the time interval for detecting a change in the page images by the detecting unit 33. The detecting unit 33 may shorten the time interval for imaging a page image by the imaging unit 32.

As described above, the detecting unit 33 of the server 20 of this example changes the time interval for screen capture based on the presence or absence of a change in the page images and the presence or absence of an operation event in the portable terminal 10. According to the change of the time interval for screen capture, the detecting unit 33 changes at least one of the time interval for imaging a Web page and the time interval for detecting a change in the page images.

<Page Image Change Detecting Process>

Next, an example of a page image change detecting process at the detecting unit 33 of the server 20 is described.

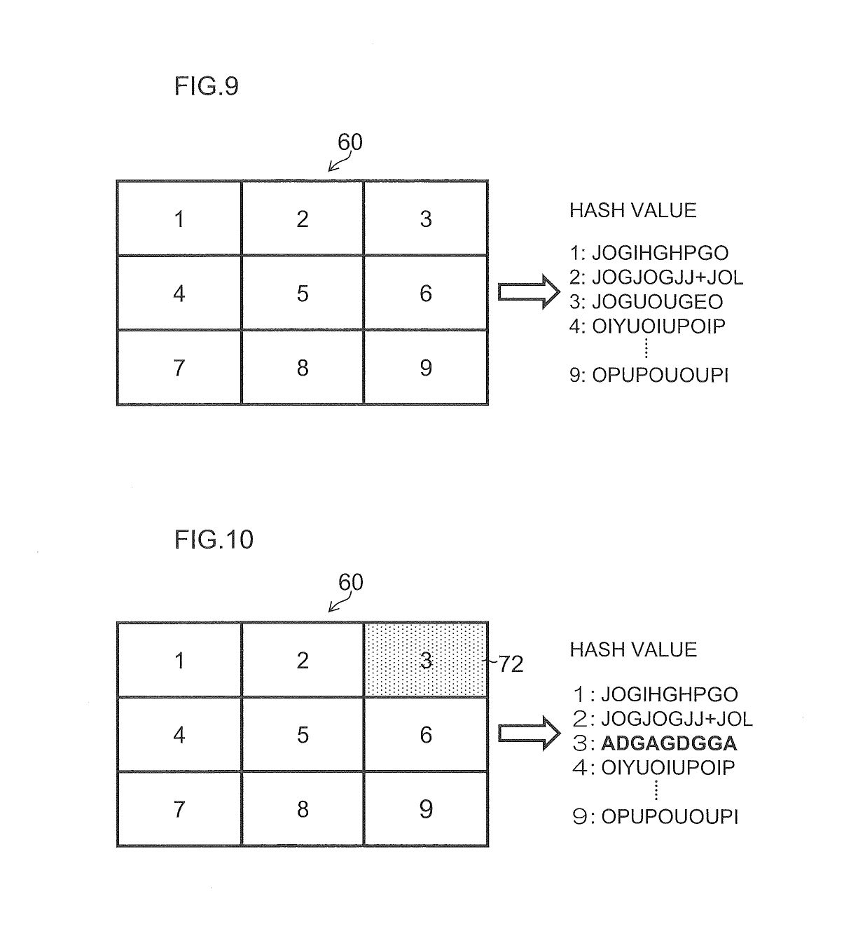

As depicted in FIG. 9, the detecting unit 33 of the present embodiment divides the page image 60 corresponding to a Web page into a lattice shape (for example, 3×3), and calculates a hash value of each of the plurality of divisional areas. Then, as depicted in FIG. 10, the detecting unit 33 specifies a divisional area 72 where a change in hash values is detected as an update area. Thus, an image including an overlap area between the update area (divisional area 72) and the display area of the portable terminal 10 (an image in the divisional area 72 or an image only in the overlap area) is transmitted to the portable terminal 10 under the control of the image transmission control unit 35.

<Portable Terminal>

The portable terminal is not restricted to the one depicted in the drawing. The present invention can be applied also to any of various potable terminals such as smartphones, PDAs (Personal Digital Assistants), and portable game machines.

The present invention is not restricted to the examples described in the specification and the examples depicted in the drawings. It goes without saying that various design changes and improvements may be performed within a range not deviating from the gist of the present invention.

What is claimed is:

1. A Web page viewing server comprising:
a viewing request accepting unit that accepts a request for viewing a Web page from a portable terminal;
a Web page obtaining unit that obtains the Web page in response to the viewing request accepted by the viewing request accepting unit;
an imaging unit that repeatedly images the Web page obtained by the Web page obtaining unit to generate page images corresponding to the Web page;
an image transmitting unit that transmits all or part of the page images generated by the imaging unit to the portable terminal;
a detecting unit that repeatedly detects a change in the page images;
an area determining unit that determines whether an update area where a change is detected in the page images by the detecting unit and a display area of the page image displayed on a display screen of the portable terminal have an overlap; and
an image transmitting unit that causes the image transmitting unit to transmit, to the portable terminal, an image including an overlap area between the update area and the display area in the page images when the update area and the display area have an overlap and does not cause the image transmitting unit to perform image transmission to the portable terminal when the update area and the display area do not have an overlap.

2. The Web page viewing server according to claim 1, wherein
when a change in the page images is not detected, the detecting unit increases at least one time interval of a time interval for imaging each of the page images by the imaging unit and a time interval for detecting a change in the page images by the detecting unit.

3. The Web page viewing server according to claim 1, wherein
when a change in the page images is detected, the detecting unit shortens at least one time interval of a time interval for imaging each of the page images by the imaging unit and a time interval for detecting a change in the page images by the detecting unit.

4. The Web page viewing server according to claim 3, wherein
when a change in the page images is detected, the detecting unit sets the time interval at a minimum time interval.

5. The Web page viewing server according to claim 1, further comprising an operation event receiving unit that receives, from the portable terminal, operation event information indicating that an operation has been performed at the portable terminal, wherein
when the operation event information is received from the portable terminal, the detecting unit shortens at least one time interval of a time interval for imaging each of the page images by the imaging unit and a time interval for detecting a change in the page images by the detecting unit.

6. The Web page viewing server according to claim 5, wherein
when the operation event information is received from the portable terminal, the detecting unit sets the time interval at a minimum time interval.

7. The Web page viewing server according to claim 1, wherein
the detecting unit divides each of the page images into a lattice shape, calculates hash values of a plurality of respective divisional areas, and specifies a divisional area where a change in the hash values is detected as the update area.

8. A Web page viewing system comprising the Web page viewing server and the portable terminal according to claim 1,
the portable terminal including
a communication unit that receives all or part of the page images from the image transmitting unit of the Web page viewing server,
an image synthesizing unit that generates, when the overlap area between the page images is received from the communication unit, a synthetic image obtained by synthesizing an image including the overlap area and the image in the display area displayed on the display screen,
a display unit that displays the images received by the communication unit and the synthetic image generated by the image synthesizing unit, and
a control unit that causes operation event information including area information indicating at least a display area of the page image displayed on the display unit.

9. A Web page viewing method of converting a Web page corresponding to a request for viewing the Web page from a portable terminal to a page image and distributing the page image to the portable terminal,
the Web page viewing server performing steps comprising:
a viewing request accepting step of accepting the request for viewing the Web page from the portable terminal;
a Web page obtaining step of obtaining the Web page in response to the viewing request accepted in the viewing request accepting step;
an imaging step of repeatedly imaging the Web page obtained in the Web page obtaining step to generate page images corresponding to the Web page;
an image transmitting step of transmitting all or part of the page images generated in the imaging step to the portable terminal;
a detecting step of repeatedly detecting a change in the page images;
an area determining step of determining whether an update area where a change is detected in the page images in the detecting step and a display area of the page image displayed on a display screen of the portable terminal have an overlap; and
an image transmitting step of transmitting, in the image transmitting step, to the portable terminal, an image including an overlap area between the update area and the display area in the page images when the update area and the display area have an overlap and not performing image transmission to the portable terminal when the update area and the display area do not have an overlap.

10. The Web page viewing method according to claim 9, wherein
the potable terminal performs steps comprising
an image receiving step of receiving all or part of the page images from the image transmitting unit of the Web page viewing server,
an image synthesizing step of generating, when the overlap area between the page images is received in the image receiving step, a synthetic image obtained by synthesizing an image including the overlap area and the image in the display area displayed on the display screen,
an image display step of displaying the images received in the image receiving step and the synthetic image generated in the image synthesizing step on the display screen, and
an operation event information transmitting step of transmitting operation event information including area information indicating at least a display area of the page image displayed on the display screen.

11. A non-transitory computer readable medium having a program causing a computer to perform functions comprising:
a viewing request accepting function of accepting a request for viewing a Web page from a portable terminal;
a Web page obtaining function of obtaining the Web page in response to the viewing request accepted by the viewing request accepting function;
an imaging function of repeatedly imaging the Web page obtained by the Web page obtaining function to generate page images corresponding to the Web page;
an image transmitting function of transmitting all or part of the page images generated by the imaging function to the portable terminal;
a detecting function of repeatedly detecting a change in the page images;
an area determining function of determining whether an update area where a change is detected in the page images by the detecting function and a display area of the page image displayed on a display screen of the portable terminal have an overlap; and
an image transmitting function of causing the image transmitting function to transmit, to the portable terminal, an image including an overlap area between the update area and the display area in the page images when the update area and the display area have an overlap and does not cause the image transmitting function to perform image transmission to the portable terminal when the update area and the display area do not have an overlap.
